(19) United States
(12) Patent Application Publication
(10) Pub. No.: US 2013/0006589 A1
(43) Pub. Date: Jan. 3, 2013

(54) ELECTRICAL MECHANISMS (EMECS): DESIGN METHODS AND PROPERTIES

(76) Inventor: Prasanna Gorur Narayana Srinivasa, Bangalore (IN)

(21) Appl. No.: 13/515,034

(22) PCT Filed: Dec. 14, 2010
(86) PCT No.: PCT/IN2010/000803

§ 371 Date: Jun. 11, 2012

(30) Foreign Application Priority Data
Dec. 14, 2009 (IN) 3083/CHE/2009

(51) Int. Cl. G06F 17/50

(52) U.S. Cl. 703/1

(57) ABSTRACT

In electrical mechanisms, a synthesis of electrical machines and mechanisms, irregularly shaped magnets are attached to different parts of the mechanism, and provide customizable tangential forces in different configurations. The presence of these tangential forces differentiates electrical mechanisms from other mechanisms. In this invention we present methods to design these magnets based on integral equations involving continuous and/or discrete variables, under a variety of constraints. We show that properly designed electrical mechanisms offer surprising properties—we can design slider-crank mechanisms which can present oscillatory forces to the load, even when driven by a constant force.

### STATEMENT OF RELATED APPLICATIONS

This patent application is the US PCT Chapter II National Phase of International Application No. PCT/IN2010/000803 having an International Filing Date of 14 Dec. 2012, which claims the benefit of India Patent Application No. 3083/CHE/2009 having a filing date of 14 Dec. 2009.

### BACKGROUND OF THE INVENTION

1. Technical Field

This invention relates to the generalization of motors to electrical mechanisms (electrical mechanisms). As opposed to motors, which are revolute or prismatic pairs enhanced with magnets (permanent, electromagnets), electrical mechanisms are entire mechanisms enhanced, in various places with magnets. In general the magnets are irregular in shape and size, and the device cannot be regarded as a set of linear/rotary motors driving a mechanism. The magnetically enhanced joints (pairs) in electrical mechanisms are called epairs. This invention presents the architecture, properties and design methods of electrical mechanisms, and shows that properly designed electrical mechanisms have surprising properties.

2. Prior Art

Related work in motion control [10]-[12], as also described in our U.S. Pat. Nos. 7,348,754 and 7,733,050, and paper [22], generally separates the problem of designing a prime mover, from that of controlling the mechanism driven by it. The prime movers are generally either rotor or linear motors, and generally but not always there is only a single actuator in the mechanism. We generalize this to actuation at all joints and links in the mechanism leading to a merger of the identities of the mechanism and the prime movers. Such devices (electrical mechanisms) can have better dynamics, fewer or no singularities, etc., compared to mechanisms driven by classical prime mover—e.g. motors.

Specifically, in (Straete et al 1996-[10]), a hybrid CAM mechanism with a constant velocity motor and a servo driving a CAM creating customizable dynamics is proposed. The paper says:
. . . Classical machines use a single motor, which generates all motions through a series of mechanical transmissions. Several mechanical components (such as linkages, cams, . . . ) transform the constant angular velocity of the motor in cyclic nonuniform motions, and assure also the synchronization between the different motions . . . . The main disadvantage of the solution is its lack of flexibility . . . . Recently, the connection of a servo motor to a mechanism has been studied in order to combine the advantages of both the classical and the servo solutions . . . . Hybrid machine . . . (is a) servo motor and a constant velocity (CV) motor that are coupled through a two degree-of-freedom (DOF) mechanism and drive a single output . . . .

Here the prime mover is still a servo motor/CV motor—an activated revolute pair in our framework, and requires active control to achieve customizable dynamics as exemplified by changing CAM timing. Our work, instead, changes the dynamics of the primemover-mechanism system, by treating the two as an indistinguishable unit, which can be designed as per Integral equation formulations, and cost effectively mass produced. The example of the IC engine flywheel shows the industrial applicability of the same.

The decoupling of the prime mover from the mechanisms is seen also in [11] and [12]-our framework couples the two. In [13] our methods can enable the disk drive servo system to achieve controlled acceleration/forces (say max acceleration limited to 1000 m/s²) by the design of the mechanism enhanced with magnetics itself, and not necessarily due to active control. Hirose et al [7] describe how multiple actuators can be used to maximize power output or minimize energy of a robotic mechanism, but the actuators are still rotary or linear motors, and separate from the mechanism. Dixon [14] describes methods to control amplitude limited robot manipulators under uncertainty, but the actuators are all revolute. In [15], Boldea et al describe linear actuators—a powered prismatic pair in our framework. The torque ripple of the switched reluctance motor in [16] can be passively reduced using our methods, instead of by current control, potentially increasing efficiency. Our methods offer improvements to the control of the multiactuator driven robot in [17] by changing the nature of the actuators themselves to reduce and/or eliminate the competition between the different actuators—the entire mechanism is designed as a coupled system. The multipole methods in [18] can be used to design the permanent magnets used, our work uses an approximate integral equation which is easy to solve. Our methods can be applied to design high precision positioning mechanisms, as opposed to a motor integrated with the mechanism in [19].

### BRIEF SUMMARY OF THE INVENTION

This invention presents a simple design method to design primarily the passive components of electrical mechanisms in a systematic fashion. Several novel devices, examples of which have been designed using this design method, will also be described. Methods of active control will be dealt with in future inventions. Our methods rely on integral equation formulations (or their discretized equivalents, possibly with both continuous and discrete parameters to be optimized). We show that properly designed electrical mechanisms show surprising properties—a slider crank can show oscillatory output torque, even with a constant force at the slider. We can design a magnetic flywheel for an IC engine, which can ideally reduce torque ripple to zero. We can configure 4-bar linkages which have stable positions which are points on a 2-d grid. 5-bar and 6-bar linkages, can be designed, which offer stable lines of motion (1-d stable regions) and stable areas of motion (2-d stable regions) respectively.

### BRIEF DESCRIPTION OF DRAWINGS

FIG. 1 illustrates a Synthesis of arbitrary position variant tangential force using position variant magnetic strengths, interacting with a fixed magnet.

FIG. 2 (a) illustrates a linear Motor versus.

FIG. 2 (b) illustrates an active Prismatic EMEC. Coils are present only on the follower (moving member).

FIG. 2(c) illustrates a Passive EMEC.

FIG. 3 illustrates a force between two magnets represented by current distributions.

FIG. 4 illustrates geometry of force production.

FIG. 5 illustrates a force profile generation.

FIG. 6 illustrates an example of a kernel showing horizontal component of force.

FIG. 7 illustrates a design of a Serial, Parallel, and General EMEC.

FIG. 8 illustrates a Slider-Crank Mechanism with Enhanced Magnetics on both crank axle and slider (red).

FIG. 9 (a) illustrates a Torque function.

FIG. 9 (b) illustrates a Magnetic Structure for zero target ripple (TOP VIEW), Connecting Rod is attached to Rotor structure.

FIG. 10 (a) illustrates a Torque function.

FIG. 10 (b) illustrates a Magnetic Structures for vibration enhancing emec (doubles torque ripple).

FIG. 11 (a) illustrates a Torque function.

FIG. 11 (b) illustrates a Magnetics for converting a slider-crank output to a sinusoidal variation of 2.7 cycles/revolution.

FIG. 12 illustrates a Torque Smoothing for 1 KW, 2-cylinder engine.

FIG. 13 illustrates a Test Jig showing magnetic flywheel (dimensions unoptimized).

FIG. 14 illustrates a Flowchart of design method.

FIG. 15 illustrates a Target Torque.

FIG. 16 illustrates a Sample Kernel, with torque at different angular separations of rotor and a single pair of stator magnets.

FIG. 17 illustrates a Target torque and Synthesized Torque.

FIG. 18 illustrates a Final Synthesized Structure.

FIG. 19 illustrates an IC Engine Design.

FIG. 20 illustrates a Double Rocker Mechanism with partially actuated pairs.

FIG. 21 illustrates a Magnet Field Strength to synthesize chirp.

FIG. 22 illustrates a Stator Magnetic Layout—Red: North on Top, Blue: South on Top: Grey: Non-magnetic Material. Rotor has North facing stator.

FIG. 23 illustrates a Chirp Torque (a) and Chirp Force with non-zero mean.

FIG. 24 illustrates a 4-bar linkage with 1 degree of freedom θ_{K} which is discrete (a stepper mechanism).

FIG. 25 illustrates a 5 bar linkage with 2 degrees of freedom θ_{K} and φ_{K}, where both are discrete but blocked.

FIG. 26 illustrates a 5 bar linkage with 2 degrees of freedom θ_{K} and φ_{K}, where φ_{K} is continuous but blocked within limits and θ_{K} is discrete.

FIG. 27 illustrates a 6 bar linkage with 3 degrees of freedom θ_{K}, φ_{K} and Ω_{K}, where φ_{K} and Ω_{K} are continuous but blocked within limits and θ_{K} is discrete.

FIG. 28 illustrates a board with magnets placed in shape of 4 bar linkages on a carom board which makes robots fly on the board.

FIG. 29 illustrates a general purpose computer.

### DETAILED DESCRIPTION OF PREFERRED EMBODIMENTS

### 1. Introduction

Our U.S. Pat. Nos. 7,348,754 and 7,733,050, and paper [22] generalized the concept of motors to electrical mechanisms (electrical mechanisms). As opposed to motors, which are revolute or prismatic pairs enhanced with magnets (permanent, electromagnets), electrical mechanisms are entire mechanisms enhanced, in various places with magnets. In general the magnets are irregular in shape and size, and the device cannot be regarded as a set of linear/rotary motors driving a mechanism. The magnetically enhanced joints (pairs) in electrical mechanisms are called epairs.

This invention presents a simple design method to design primarily the passive components of electrical mechanisms in a systematic fashion. Several novel devices, examples of which have been designed using this design method, will also be described. Methods of active control will be dealt with in future inventions. Our methods rely on integral equation formulations (or their discretized equivalents, possibly with both continuous and discrete parameters to be optimized). We show that properly designed electrical mechanisms show surprising properties—a slider crank can show oscillatory output torque, even with a constant force at the slider. We can design a magnetic flywheel for an IC engine, which can ideally reduce torque ripple to zero (it was non-zero in our heuristically designed IC engine flywheel in [22]). We can configure 4-bar linkages which have stable positions which are points on a 2-d grid. 5-bar and 6-bar linkages, can be designed, which offer stable lines of motion (1-d stable regions) and stable areas of motion (2-d stable regions) respectively.

We believe our work is the first to do a systematic synthesis of electrical prime movers and mechanisms, and present systematic design methods for the same. We are unaware of any directly related work. The work is applicable generally, in robots, automobiles, aircraft, spacecraft, etc. The power levels are comparable to medium power pneumatics (see the discussion in [22]).

This invention summarizes the architecture of electrical mechanisms (elaborating our previous discussion in [22]), introduces important design principles, and finally presents a detailed example of the capabilities of a properly designed slider-crank EMEC. First, we illustrate the concept through the simplest of electrical mechanisms, a prismatic pair, showing an integral equation formulation for the design (Section 2). The structure and design of electrical mechanisms follows (Section 3). A detailed discussion of the slider-crank follows (Section 4), and then a description of the design method, an example of its operation, and then examples of a wide variety of devices which can be designed using the invention.

### 2. A Simple EMEC

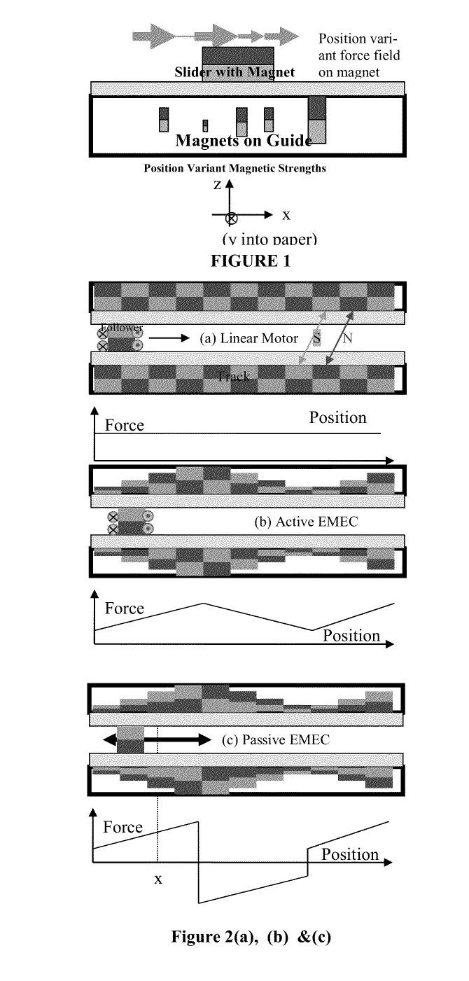

We use a simple example to illustrate the idea of an EMEC. FIG. 1 shows a simple EMEC, composed of a single prismatic pair, enhanced with magnets on both the guide and the slider. We wish to control the motion of the slider, of mass m, w.r.t the guide. Newton's law is

m\ddot{x}=Fₜₒₜ

where Fₜₒₜ is the total force acting on the slider, from all sources. If the total applied force is constant, so is the acceleration of the slider.

In many circumstances, however, it is desirable to have a constant force resulting in a non-constant acceleration, or a non-constant force resulting in a constant acceleration. For example, in a vibration jig, the acceleration of the table holding the object should have all frequency components up to the maximum vibration frequency to be tested. It is preferable that the prime mover driving the jig should work at a constant force/torque output.

How is this possible? For a non-constant acceleration, the total force has to be non-constant (assuming the mass is constant, which is true in mechanisms we discuss here). However, if a portion of this force is provided by the internal structure of the mechanism, then the acceleration of the slider can be non-constant, even if the applied external force is constant. An EMEC achieves this by using internal electromagnetic forces, which are non-contact, repeatable, and are approaching power levels of medium power pneumatics. The internal electromagnetic force is tangential to the contact surfaces, differentiating electrical mechanisms from all other mechanisms, and leads to some surprising properties. There are also normal forces due to the magnetics, but for the class of electrical mechanisms considered, these can be subsumed in the contact reactions, and do not figure in the dynamics. Electrical mechanisms having global interactions require these forces to be accounted for, and the equations presented in the invention have to be generalized.

Considering the prismatic pair again, let us denote the internal force by Fₘ. Then Newton's law becomes (for time and position dependent forces):

m\ddot{x}=Fₜₒₜ(x,t)=Fₑₓₜ(x,t)+Fₘ(x,t)

An appropriate tangential Fₘ(x,t) can enable a desired acceleration for a given external force. In the electrical mechanisms we consider, this force is generated by the differently sized magnets interacting with each other (there are other means of generating these forces, e.g. attraction between magnets and magnetic materials, eddy/hysteresis effects, etc., and these alternative embodiments are included in the scope of this invention, is time invariant, but changing as a function of position (see FIG. 1). This change of tangential internal force w.r.t position is critical to the EMEC, and accounts for its properties.

### Prismatic EMEC Versus Linear Motor

It is illustrative to compare a linear motor with a prismatic EMEC in more detail. FIG. 2 compares a linear motor with its closest comparable EMEC—the prismatic epair. FIG. 2(a) shows a simplified linear motor. Regularly spaced permanent magnets in the track interact with the electromagnet in the follower. By a proper phasing of the current in the follower (polarity reversal after each pole piece is crossed), a constant (roughly) forward force is generated on the follower. The residual ripple in the force can be smoothed out by another follower which is offset by half a pole pitch, and mechanically connected to the one depicted, as is well known in the design of linear motors (reduction of cogging torque).

FIG. 2(b) shows a prismatic active EMEC. Unlike the linear motor, the pole pieces are not of the same magnetic strength. The strength increases and decreases in a “sinusoidal” fashion with position (in general the spacing can be irregular too). With the same excitation as before, the forward force increases and decreases in a sinusoidal fashion.

Finally, FIG. 2(c) shows a completely passive prismatic EMEC. At any position, say “x”, the net force is the difference between the backward pull of the (smaller) magnets to the left of x, and the forward pull of the (larger) magnets to the right, and is related to the slope of the magnetic strength curve. A positive slope implies a forward force, and a negative slope a backwards force. The total forward force summed over all positions is zero, since the system cannot provide net energy.

Why do we need such position variant structures? In short, to compensate for nonlinear mechanism and prime mover dynamics which change as a function of position/configuration. At those positions where the prime mover forward force (as reflected through the mechanism position function) is weak, the passive EMEC can add to the forward force, and vice versa in those positions where the prime mover is excessively strong.

An IC engine furnishes an excellent example. At top dead center (TDC), the combustion is just starting, and the crank is in line with the connecting rod resulting in a small lever arm. Due to both effects, the net torque delivered is zero. Further into the cycle, the combustion completes, and the lever arm is also large, resulting in a torque much larger than the mean torque. Further into the cycle, during compression (just before TDC), the net torque delivered is negative, and energy is absorbed by the engine from the flywheel. This position variant torque can be smoothed by putting a magnetic position varying load, which absorbs/releases energy losslessly with the IC engine (Section 4).

### Synthesis of Fields and Forces

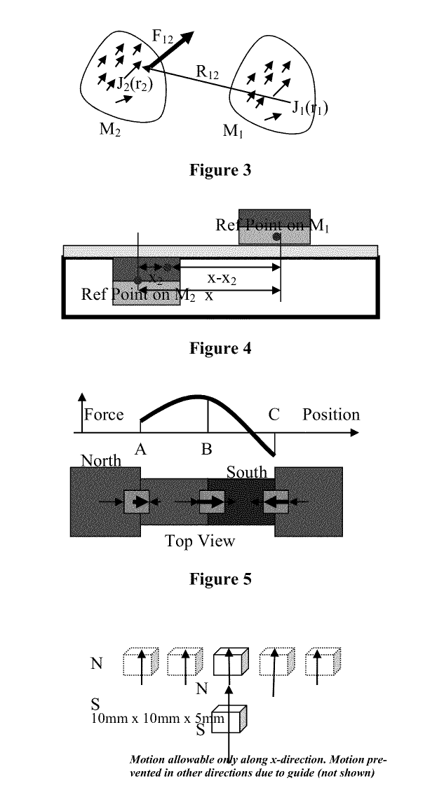

The fundamental way a position variant magnetic force is generated is by generating a position variant magnetic field. The field produced by a single elementary magnet shows a fixed variation with distance—approximately inverse square. Arbitrary position variant magnetic fields (not inverse square) in general require multiple magnets whose size, material strengths, etc., varies with position, i.e., a spatial distribution of magnets (FIG. 3). The spatial distribution of magnets can be calculated as follows.

First, the origin of magnetic fields can be identified as current densities \vec{J(\vec{r})} (or magnetic moments, this is equivalent) in space. Two interacting magnets M₁ and M₂ can hence be identified by associated current densities \vec{J₁(\vec{r}₁)}=\vec{J₁(x₁,y₁,z₁)} \vec{J₂(\vec{r₂})}=\vec{J₂(x₂,y₂,z₂)} in their respective regions. These current densities depend on the materials used for these magnets. Using the Biot-Savart law [23][24], the magnetic field B and forces F₁₂ acting on M₂ due to M₁ as arranged in FIG. 3 are given by the relevant cross products:

$$B ( \vec{{r}_{2}} ) = \frac{{μ}_{0}}{4 π} \int \vec{{J}_{1} ( \vec{{r}_{1}} )} \times \frac{{{r}^{⋒}}_{12}}{{R}_{12}^{2}} d {V}_{1} , Teslas \\ {R}_{12} = \vert \vec{{r}_{2}} - \vec{{r}_{1}} \vert , {{r}^{⋒}}_{12} = \frac{\vert \vec{{r}_{2}} - \vec{{r}_{1}} \vert}{{R}_{12}} \\ {F}_{12} = \int \vec{{J}_{2} ( \vec{{r}_{2}} )} \times B ( \vec{{r}_{2}} ) d {V}_{2} Newtons \qquad ( 1 )$$

From Equation (1), the elemental force between an elemental current density comprising the magnet M₁, \vec{J₁(\vec{r₁})} at location \vec{r₁}, and the elemental current density comprising the magnet M₂, \vec{J₂(\vec{r₂})}, at location \vec{r₂}, depends on the vector displacement between them R₁₂=|\vec{r₂}−\vec{r₁}|. Since we are discussing a 1-D prismatic pair, this reduces to the distance between the elemental currents, x₁₂=x₂−x₁. The total force F₁₂ between the magnets M₁ and M₂ is the integral of all these elemental forces, over both the regions enclosed by the magnets.

Now, in our prismatic epair, M₁ is rigidly attached to one link, and M₂ to the other. As the links slide against each other, the force F₁₂ changes, due to the change in the elemental forces. The change in the elemental force is due to the change in the distance between two elemental current densities

x₁₂=x₂−x₁→x′₁₂=x′₂−x′₁.

where the primes denote the new positions. We assume that the currents are constant—we are discussing permanent magnets here. Since the motion is rigid, the change in distance is the, same for all pairs of elemental current densities, and can be equated to the change in distance x between a reference point on the first magnet M₁ and a reference point on the second magnet M₂ (say centroids).

x′₁₂=x′₂—x′₁=x₁₂+x

We use “x” instead of “Δx”, for reasons which will be clearer below. Given an x, the relative position of the magnets is completely specified. Then, from Equation (1) when the links slide, the field B is a function of both x₂ and x (x₁ is integrated out), but force F₁₂ is only a function of x (x₁ and x₂ are integrated out), and the current densities (or equivalently magnetic moments) in the magnets. We can write:

B(x₂)=B(x₂,x)

F₁₂(x₁,x₂)=F₁₂(x=x₁−x₂)=κ(∫J₁,∫J₂)f₁₂(x) (2)

Where κ(∫J₁,∫J₂) depends on the integrals of the elemental current densities or equivalently magnetic moments in the magnets. Equation (2) is intuitive—the force between two magnets depends only on (a) the magnetic moments inside the magnets and (b) the separation between them, in a 1-D setting (in a 3-D setting, the relative orientation also matters). If the force F₁₂ is specified at all relative distances, the resulting integral equation can be solved to yield the current densities J₁,J₂, at all points in the interior of both magnets. This is the basis of our approach.

However, a simpler form of Equation (2) suffices for our 1-D prismatic pair. From the third equation of Equation (1), and the first equation of Equation (2), it is easy to see that (see FIG. 4):

F₁₂(x₁,x₂)=F₁₂(x=x₁−x₂)=

∫J(x₂)B(x₂,x)dx₂=

∫J(x₂)B(x−x₂)dx₂ (3)

Here we have used the fact that B̅(̅x̅₂̅)̅, the field density per unit length, produced at location x₂, depends only on the distance from the reference point on M₁ to the current location x₂, which is x−x₂.

The intuition is that the force on magnet M₂ due to M₁ at a distance x, is composed of the sum of all the elemental forces produced by a (linear) current density at x₂, multiplied by the field strength at that point, which is at a distance x−x₂ from reference point on magnet M₁. (FIG. 4). This is a convolution integral. With a slight change of notation, this can be re-written as the sum of elemental forces produced per unit length on a unit current J₂ at x₂, f(x−x₂) multiplied by the ratio of the actual current density to a unit current:

F₁₂(x)=∫K₂(x₂)f(x−x₂)dx₂ (4)

We shall denote f(x) as the kernal (Newtons per meter), and the dimensionless ratio K₂(x₂) will be called the equivalent strength. In many cases, we have a finite number of magnets (not a continuous distribution) and Equation (4) changes to.

$${F}_{12} ( x ) = {\sum }_{i} {K}_{i} f ( x - {x}_{i} ) \qquad ( 5 )$$

Here the kernel is a force (Newtons) and can be computed by finite-element (or other) methods, given the shape and properties of M₁. We shall discuss how to determine the equivalent strengths below.

We note that the convolution integral is valid in this form only for a 1-D pair. For 2-D and 3-D structures, magnet orientation enters the equations too, and Equation (2) does not reduce to such simple forms.

We also note that the same equation can be used for forces due to induction and/or hysteresis members attached to the mechanism (only for the former instead of yielding a force, we get a force per unit velocity (damping constant)). Only the integral of the kernel over the entire space need not be zero, as in the lossless case composed solely of magnets. In the rest of this specification, we shall speak only about lossless kernels for magnets, but the extensions to general induction/hysteresis forces shall be taken by implication.

While our discussion has been with forces, it is completely equivalent to using energy methods (e.g. the Lagrangian formulation (kinetic energy—potential energy)). The only difference is that the electromagnetic potential energy has to be included in the Lagrangian, as a function of generalized co-ordinates.

### Field Strength Slope and Force Generation—Intuition

We give additional intuition as to how a position varying tangential force/torque is generated by an epair. FIG. 5 shows a prismatic epair, with a small top member sliding on a bottom member. Both top and bottom members are magnetized, with strengths proportional to the areas shown. The top member has its north pole facing the bottom member. The net force on the top magnet is the vector sum of the interactions with each of the bottom magnets. For illustration, we consider only forces from the neighboring magnets. At position A, the strong repulsive force from the left magnets, overcomes that of the right, resulting in a small force to the right. At position B, the attractive force from the south pole of the right magnet adds to the repulsion from the left one, resulting in a large rightward force. At C, the backwards attraction of the south pole adds to the repulsion of the north pole to the right, resulting in a strong backwards force. At intermediate positions, the force profile is as shown in the curve. Our integral equation technique determines the areas and polarity of the magnets such that a desired force profile is realized. Clearly it is the change of the magnetic strength which results in a net force. If we use a repulsive convention for the magnetic strength, then a downwards slope in the strength implies a forward force and an upwards slope implies a backwards force. For revolute pairs, a torque profile is analogously generated.

### Example of a Kernel

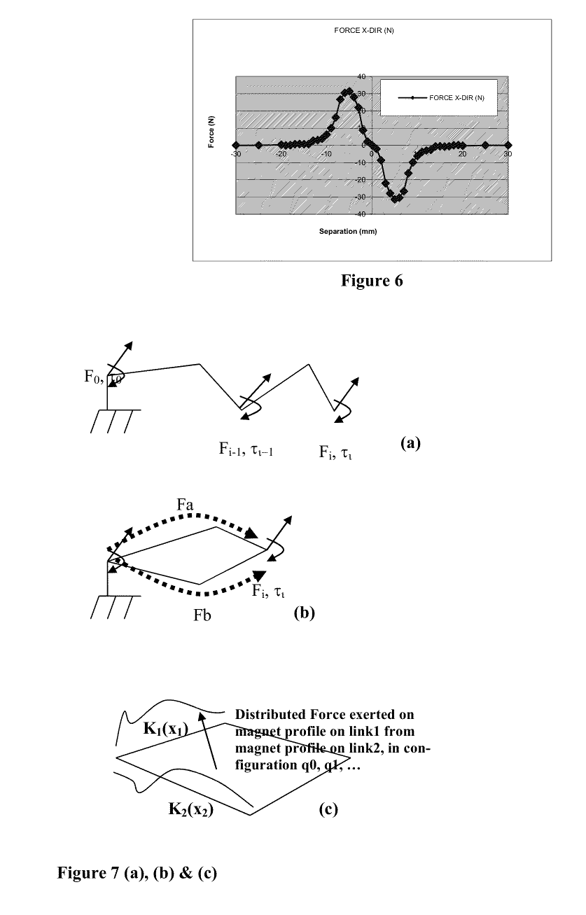

An example kernel determined by finite-element analysis (FEM) is shown in FIG. 6, where two 10 mm×10 mm×5 mm (approx.) neodymium magnets are shown, one attached to each link in the prismatic epair. Opposite poles face each other, resulting in attractive forces between the magnets. The vertical separation is 1 mm (air gap). The horizontal separation varies. When the top magnet is far to the left (more than 20 mm apart), the interaction is weak, and the horizontal force in the positive x direction is weak. As it approaches, the horizontal force first increases, peaks at 30 N at 5 mm separation, and then rapidly goes to zero when the magnets are right on top of each other (here the force is vertical). The force reverses direction after the top magnet slides past the bottom one. The integral of the force is zero, because the system is passive. In general, modern neodymium magnets are powerful enough to offer 10 s of Newtons of force at a few mm separation, with structures only a couple of cm² in area.

### 3. Optimization of Equivalent Strengths

Generating/computing an appropriate kernel is only half the story. The other half is to determine and synthesize magnetic structures with the correct equivalent strengths as per Equation (4) or(5). Determining optimal equivalent strengths is discussed in detail below. But first we mention a couple of points regarding realization of equivalent strengths of the magnets involved:
One method is to use different materials, and keep the same dimensions. It is easily seen from first principles, that if the B-H curve is scaled by a factor of N, all fields scale up by a factor of N, and forces by a factor of N². The same effect can be obtained by changing the air gaps in the flux paths.
Alternatively, the dimensions of the magnets can be chosen to generate specified equivalent strengths (using FEM analysis). Note that this is not a simple scaling of dimensions, as the field distributions for differently sized magnets differ. An FEM analysis has to be performed, to determine the dimensions of the magnets which can generate an equivalent strength profile with respect to (w.r.t) position (or x). Alternatively, a table of kernels, with different equivalent strength profiles, corresponding to different dimensions, can be used in the optimization directly (see the discussion on—heuristics just after Equation (7)).

### Optimization Methods:

We show below that an optimal profile of equivalent strengths can be selected using convex and non-convex optimization methods [25]. The error in force at each position, can be in some cases, expressed as a convex function of the equivalent strengths. Various criteria can be used—minimization of the mean-square error over all positions (L₂), minimization of the maximum error over all positions (L_{∞}), etc.

Our discussion here begins with the optimization of an EMEC with a single epair. In such a case, the desired magnetic force/torque profile, as a function of epair configuration is specified to yield appropriate mechanism dynamics (see the section “Epairs to Electrical mechanisms”, also). In general, however, every force profile cannot be exactly synthesized. There is residual error, which can be minimized (using convex optimization [25]) by choosing optimal equivalent strengths, as shown below.

Our notation is as follows. f_{target}(x) is f the force as a function of x, targeted to be synthesized, f_{synth}(x) is the synthesized force, and the kernel is denoted by f(x), and is obtained apriori from FEM analysis. The error at each position x is Err(x). The optimization can include limits on equivalent strengths, due, say to manufacturing constraints. Other constraints (sums, differences, etc.) on equivalent strengths can also be included if required.

First, for an EMEC with a single epair, a mathematical specification of the optimization procedure is given below:
min_{K} E₂ or E_{∞}
Subject to:

E₂=∫Err²(x)dx,E_{∞}=Max_{X}(Err(x))

Err(x)=|f_{synth}(x)−f_{target}(x)|

f_{synth}(x)=∫K(x′)f(x−x′)dx′, (6)
Under Constraints:
Bounds: K^{min}≦K(x)≦K^{max}
Other Constraints on K's

Equation (6) is written for a continuous profile of magnets. For a discrete set of N magnets, the integrals are replaced by sums. Since the objective function (L₂ or L_{∞}) is convex w.r.t K, and these constraints are also convex (bounds, and similar convex constraints) Equation (6) specifies a convex optimization, solvable using state-of-art solvers. In several cases, however, non-convex constraints and/or objective functions appear, and general non-linear optimizers, and statistical methods like simulated annealing, swarm intelligence, etc., have to be used.

While Equation (6) is written with respect to a prismatic pair, the same equations (with changes from linear position x to angular position θ, torque instead of force, if required) can be used for any of the epairs in an EMEC. We use it for a revolute pair in Section 4.

A wide variety of objective functions and constraints can be used in Equation (6). Depending on the specific constraints and/or objective function, the resulting optimization may not remain convex, and in general a non-linear non-convex optimization procedure may have to be used.

### Constraints

A wide variety of constraints can be incorporated in the formulation, and a few are listed below:
Maximum and Minimum limits on equivalent strengths or the kernel itself. These can reflect both manufacturing limitations, as well as space limitations at various configurations in the mechanism. The limits can be varying with position (or w.r.t general mechanism configuration).

fₘᵢₙ(x)≦f(x)≦fₘₐₓ(x)

kₘᵢₙ(x)≦k(x)≦kₘₐₓ(x)
Total magnetic material used in the mechanism may be limited—due to exemplarily space constraints

∫f(x)dx≦Max

∫K(x)dx≦Max
Rate of change of equivalent strength and/or the kernel, due to manufacturing limitations

Min≦f′(x)≦Max

Min≦K′(x)≦Max

The derivative can be discretized, and a finite difference approximation used instead of the continuous formulation. Using a forward derivative at points xₙ and xₙ₊₁ (a centered derivative yields a better approximation), we get

$$Min \leq \frac{f ( {x}_{n} ) - f ( {x}_{n - 1} )}{Δ x} \leq Max$$

$$Min \leq \frac{K ( {x}_{n} ) - K ( {x}_{n - 1} )}{Δ x} \leq Max$$

Several equivalent strengths can be set equal to each other—this can potentially simplify manufacturing, since fewer sizes of magnets have to be fabricated. A variant of this is to maximize the number of magnets whose strength is equal to each other.
Maximum change in the field as the mechanism moves may be limited—this can be used to enhance material stability by limiting demagnetizing fields (limits to how negative H (amperes/meter) can become). In each configuration of the epair, the total demagnetizing field can be computed as a function of equivalent strengths K(x), and a constraint imposed. Under linearity assumptions, this translates to limits on equivalent strengths K(x).
There can be limits to the internal magnetic forces at different configurations in the mechanism, as it moves (to limit, say internal stresses). These can be translated into constraints on equivalent strengths, based on the static (and dynamic) force analysis of the mechanism. For example, if the maximum normal force has to be kept within bounds, exactly the same kernel Equation (5) is used, but with a kernel fₙₒᵣₘₐₗ(x) representing normal (not tangential) forces—these are also obtained using an FEM analysis.

$${F}_{12}^{normal} ( x ) = {\sum }_{i} {K}_{i} {f}_{normal} ( x - {x}_{i} ) \leq F Ma {x}_{12}^{normal} = {σ}_{ma x}^{12} A$$

Where σₘₐₓ¹² is the maximum stress in the material, and A is the area over which the force F₁₂ acts. This constraint couples all the different equivalent strengths together.
Other constraints can be included. We can specify the stable/unstable states at various positions, along with the maximum holding force, and the magnetics have to be designed to yield these states. The simplest specification is a minimal depth of the energy well for a stable state, which is a specification on the integral of the force. An example is

$${\int }_{x ∈ Well} {F}_{12} ( x ) d x = {\int }_{x ∈ Well}^{ } {\sum }_{i} {K}_{i} f ( x - {x}_{i} ) d x \geq {E}_{m i n}$$

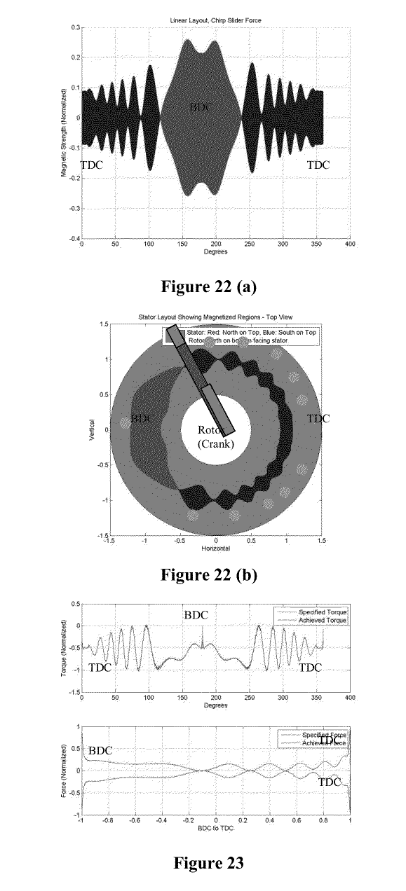

One such constraint is used at each well. Unstable states are similar, but the energy well becomes an energy hill. This constraint can be used to specify the stable positions of stepper mechanisms (see FIGS. 22, 24, 25, 26, 27, and 28).

These constraints can be interpreted in the context of our earlier patent applications on decision support systems (PCT/IN2009/000390, and PCT/IN2009/000398, and all those referred to therein), and all the techniques mentioned therein are mentioned by reference. Exemplarily, the intuitive manner to specify constraints (the constraint manager), the graphical visualization of extended relational algebra, the information estimator using polyhedral volume, the output analyzer, a compressed database of polyhedra, etc are all usable in this invention, and included herein. The compressed database of polyhedra determines, exemplarily, an optimal mix of vertex and faces to represent a set of polyhedra. If a polyhedron is extended by adding a new vertex, creating M new faces in N-dimensions, then memory is reduced by specifying the single vertex instead of M new faces, if M>=2. If, however one or more faces are required for other polyhedra in the set, or to increase processing speed, etc., then the new faces can be advantageously specified in the database. The facilities provided in the information theory module to create new constraints with the same volume/information content can be used to create new geometric structures with the same volume of magnetic material, for example.

### Objective Function

In addition to the L₂ or the L_{inf} norm, a variety of other criteria can be used. For example
The error can be frequency weighted, with low frequency components given more importance, since apart from the resonant frequencies, system response to high frequencies is typically less. This is equivalent to filtering the error profile with a low pass filter. As long as the filter coefficients are all positive, the objective remains convex, and convex optimization can be applied for convex constraints. If the filter coefficients are negative, then general non-linear optimization techniques have to be applied.
With the same convention as in Equation (6), and a filter h(x), we have
min_{K} E₂ or E_{∞}
Subject to:

E₂=∫Ferr²(x)dx,E_{∞}=Max_{X}(Ferr(x))

Ferr(x)=h(x) [symbol] Ferr(x)
If error components at one or more resonant frequency have to be eliminated, then these respective frequencies have to be converted to spatial frequencies, depending on the mechanism's operating speed, and an appropriate filter h(x) [see above] designed for use in the optimization.
Equation (6) can be generalized to handle a situation where the profiles of both the moving members have to be designed. Then the kernel f(x) itself has to be designed, in addition to the equivalent strengths. The target synthesized force/torque becomes a quadratic function of the unknowns, as shown below:
min_{K,f} E₂ or E_{∞}
Subject to:

E₂=∫Err²(x)dx,E_{∞}=Max_{X}(Err(x))

Err(x)=|f_{synth}(x)−f_{target}(x)|

f_{synth}(x)=∫K(x′)f(x−x′)dx′,Quadratic
Under Constraints:
Bounds:

K^{min}≦K(x)≦K^{max}

f^{min}≦f(x)≦f^{max}
Other Constraints on K's and f's

Here the only change is that the kernel is also a variable, and the minimization is with respects to both the unknowns. One solution method (there are others) can be iterative
keep the kernel and/or equivalent strength constant, and solve the resultant linearly constrained problem. An example is given subsequently below.

While the above equations are written for a continuous profile of magnets, for small volume manufacturing using discrete magnets, a discrete version of these equations is appropriate. If we minimize the error in the synthesized force at M equally spaced positions x, using N magnets, also equally spaced. Typically M>N, since we need to check the error at positions in between the magnets also. The synthesized force and error at different positions xᵢ can be then written as a matrix equation

Specification at M points, with N Magnets:

$$i = 1 … M , j = 1 … M \\ \vec{{f}_{synth} ( \vec{x} )} = {[ {F}_{ij} ]}_{M \times N} \vec{K} , \\ \vec{Err ( \vec{x} )} = \vec{{f}_{synth} ( \vec{x} )} - \vec{{f}_{target} ( \vec{x} )} \\ \vec{x} = {[ {x}_{1} , {x}_{2} , … , {x}_{m} ]}^{T} Δ x = \frac{{x}_{m} - {x}_{1}}{N} \\ {F}_{ij} = f ( {x}_{i} - {x}_{j} ) Δ x , \vec{K} = {[ {K}_{1} , {K}_{2} , … , {K}_{N} ]}^{T} \\ \vec{{f}_{synth} ( x )} = {[ {f}_{synth} ( {x}_{1} ) , {f}_{synth} ( {x}_{2} ) , … , {f}_{synth} ( {x}_{m} ) ]}^{T} \qquad ( 7 )$$

In the absence of constraints on K, singular-value-decomposition (SVD) can be used in Equation (7), for minimizing the squared error. The max error can be minimized using Linear Programming. In the general case, where constraints are present a convex optimization solver is required. The output of this optimization is a specification of the equivalent strengths of all magnets in this prismatic pair.

The discretization need not be uniform in time. Indeed it is well known from the theory of Gaussian-Quadratures 0, that non-uniform steps can improve the accuracy of the integral estimate. In this context, this implies that with fewer magnets we can achieve a given accuracy level. However, if exact Gaussian quadratures are used, then the magnet sizes are in general irregular, and can cause manufacturing difficulties, in the absence of large economies of scale.

A simpler scheme from a manufacturability perspective is to use standard magnets. Now the optimization is a selection from a discrete set of magnets, to optimize any desired criterion (e.g. in Equation 6/Equation 7). This discrete optimization is in general computationally intensive, but efficient heuristics exist to solve such problems today.

What force profiles can be generated thus? From Equation (4), taking (spatial) Fourier Transforms

F_{synth}(jw)=K(jw)F_{eq}(jw) (8)

The Fourier Transform of the synthesized force F_{synth}(jw) is the product of the Fourier Transforms of the kernel and the equivalent strength. Clearly the set of all derivable force profiles is spectrally limited to the spatial frequencies present in the kernel, and those in a realizable equivalent strength profile (maximum rate of change of magnetization direction and strength). Both are limited by manufacturing processes—the kernel's spatial frequencies are limited to the smallest magnetic domain which can be easily manufactured, and the equivalent strength by the sharpest change in magnetization orientation possible. Disk drive technologies are proof that spatial frequencies in microns per cycle can be constructed. The spectral approach can also be used for optimization in the spectral domain (details omitted).

Epairs to Electrical mechanisms

We have discussed the structure and design of the simplest EMEC, composed of a single epair. Based on Equation (6) we briefly discuss extensions to electrical mechanisms composed of multiple pairs.

In FIG. 7(a), we have a serial manipulator, in a certain configuration specified by inter-link angles (φ0, φ1, φ2, . . . ). For simplicity, we treat a planar EMEC, but the results generalize for a general 3-D EMEC, with more configuration parameters. The force/torque at joint I is given by Fᵢ and τᵢ respectively, and can be determined as a function of the end-effector forces/torques at this configuration, using standard kinematic equations [1][2][3][4]. As per Section 2, the normal forces due to the magnetics in epairs can be ignored, and the design of the EMEC reduces to designing each epair with specified tangential forces/torques each configuration, as per Equation (6). The design of parallel manipulators is FIG. 7(b) similar, with the additional constraint that the forces/torques have to be optimally partitioned amongst the different paths leading to the end-effector.

Extension to General Electrical Mechanisms with Global Interactions

The same equations can be used for a general EMEC, but now the equivalent strengths of all magnets jointly enters the optimization. The kernel is composed of portions corresponding to the forces exerted by each magnetized section, on any member, in a given EMEC configuration. The forces on all members are jointly designed. In FIG. 7(c), the force on member 1 due to equivalent strength profiles on member 2 can be written as

F₁₂(q₀,q₁, . . . )=∫∫f(K₁(x₁),K₂)(x₂),q₀,q₁, . . . )dx₁dx₂

Where x₁ refers to magnet positions on link1, x₂ to those on link2, and q₀, q₁, . . . are the joint variables (mechanism configuration parameters—angles here). K₁(x₁) and K₂(x₂) are the equivalent strength profiles of the magnets on each link. Under assumptions of material linearity, the force is linear in each equivalent strength. Unfortunately, the change of mechanism geometry with respect to q₀, q₁, . . . implies that the integral cannot be written in general as a convolution of a kernel and an equivalent strength. A general integral equation has to be solved.

4. Applications of and Devices Arising from the Invention

We present an analysis of the dynamics of the important slider-crank EMEC (i.e. a slid-er-crank mechanism enhanced with magnets at various places). Our major conclusions are that the output force need not be related to the input force through the mechanism's transfer function, but can be within limits arbitrary. This offers new features in the design of mechanisms, wherein dynamics can be partly decoupled from kinematics.

The output force/torque of an EMEC is the combination of the input force/torque, reflected through the mechanism position function, together with internal magnetic forces/torques. The output force/torque in general changes with mechanism configuration. This changing force/torque will be called the output force/torque function of the EMEC. We show that electrical mechanisms can have a wide range of output force/torque functions, limited primarily by the special resolution of the magnetic kernel. Unlike classical mechanisms, the input torque/force and output force/torque are not related by a geometric/kinematic parameter (e.g. in a lever/gear etc.), but depend on the magnetic field strength, which is independent of kinematics (as long as the magnetics fits inside the space provided by the mechanism in all its positions). The dynamics can even be changed, by changing the magnetics, while keeping the rest of the mechanism invariant.

We discuss a lossless slider-crank EMEC, so that the input power is completely and instantaneously transferred to the output, if the magnetic energy storage was absent. We also assume that the mechanism is moving slowly, so that electromagnetic wave effects are negligible (quasi-static—true in most cases). The temporal (not spatial) bandwidth of our slider-crank EMEC is hence infinite. Spatial bandwidth is discussed in detail below.

### Slider-Crank Mechanism

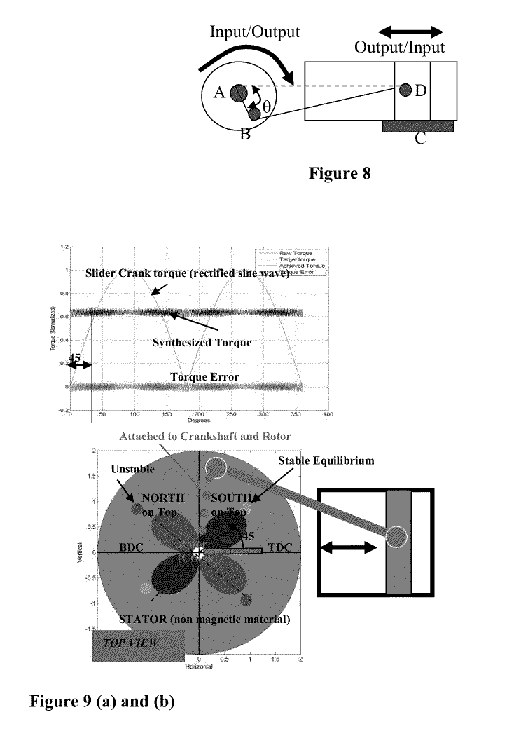

We shall discuss the behavior of the slider-crank EMEC in FIG. 8 when a force is applied to the slider and output torque taken from the crank (e.g. an IC engine). The opposite case, where the crank is driven is omitted for lack of space, but is qualitatively similar. The structure of the mechanism imposes a zero output function at the mechanism positions corresponding to top and bottom dead centers (TDC/BDC).

A slider-crank (FIG. 8) can be converted into an EMEC by adding magnets at one or more of the following:

a) The revolute pairs (crankshaft bearing A and the crank pin B in FIG. 8)
b) The prismatic pair (slider C) and its pin D to the connecting rod.

In case (b) the reciprocating motion of the prismatic pair and its pin imposes a half-period symmetry. The magnetic forces/torques generated in the second half cycle are time reversed copies of those generated in the first half cycle. No such constraint is present for the revolute pair on the crank axle (and its pin). Hence, for maximum flexibility, we discuss enhancement of the crankshaft (it can be shown that enhancement of the crank pin does not lead to new capabilities).

We discuss the customizability of our slider-crank EMEC, based on a spatial Fourier Decomposition of the output force, given a constant force in the direction of motion. If a sinusoidal output of a given spatial frequency can be synthesized, any output function having spatial frequencies up to this bandwidth can be synthesized using superposition of magnetic structures corresponding to each spatial frequency. This is based on the linearity of Maxwell's equations, and approximate linearity of magnetic materials (details are skipped for brevity).

To keep the discussion simple, we shall assume that the connecting rod is long, so the force F on the slider and the torque τ on the crank are related by

τ=F sin(θ)

where θ is the angle of the crank from the line joining the centers. The discussion does not change qualitatively for short connecting rods. The torque on the load is given by

τ=F sin(θ)+τₘ

where τₘ is the magnetic correction to the raw torque F sin(θ). A specified force F_{spec}(θ) should result in a specified synthesized torque T_{spec}(θ), using magnetic kernels τ(θ). The magnets are designed using the discrete version of Equation (6) for torque synthesis, with N magnets equally spaced in angle, and error evaluated at M points θₖ.

$$k = 1 … M ; M \geq N$$

$$T ( {θ}_{k} ) \approx {\sum }_{j = 0}^{N - 1} K ( {θ}_{j} ) τ ( {θ}_{k} - {θ}_{j} ) Δ θ ; Δ θ = \frac{2 π}{N}$$

$${τ}_{err} ( {θ}_{k} ) = {τ}_{m} ( {θ}_{k} ) - ( {T}_{spec} ( {θ}_{k} ) - {F}_{spec} sin ( {θ}_{k} ) )$$

Our approach will be to design magnetics for T_{spec}(θₖ) of various spatial frequencies and amplitudes. Optimization to minimize the error (either mean-square -L₂- or max -L_{∞}) is done using SVD techniques, as per Section 3, since we do not have constraints on equivalent strengths for our examples.

Our kernel is a scaled version of FIG. 6, and dimensioned [22] such that it is effective for use in torque smoothing of an IC engine working at 1 KW at 2000 RPM—it occupies an angular extent of 2 degrees at 10 cm radius. The spatial spectrum (not shown) has significant frequencies till 30 cycles/revolution. Hence we expect our designs to be able to match any torque function having components till 30 cycles/revolution, and this is indeed the case (these results are not shown for brevity).

Here, since we deal with fundamental capabilities of electrical mechanisms, we present only normalized results, and results with actual dimensions indicate power-size levels approaching medium-power pneumatics for comparable dimensions.

We illustrate how magnetics can smooth the jerky torque produced by a slider-crank driven by a constant force (in direction of motion). The crank torque corresponding to a constant force input at the slider is shown in FIG. 9, and is a rectified sine wave. By proper magnetics, this rectified sine wave can be converted to sine wave of any desired different frequency and desired amplitude (within limits), as along as the average torque per cycle is kept invariant (for a passive EMEC).

FIG. 9(a) shows the raw torque (rectified sine-wave purple), the synthesized torque (blue) and the error (magenta) for zero target ripple (constant torque). FIG. 9(b) shows the magnetic structure. When used in an IC-engine, the Rotor is attached to the crankshaft, and stator is attached to the engine block (stationary). The stator is composed of a disk of non-magnetic material, into which magnets of varying sizes are inserted in the “butterfly-shaped” areas. Red color indicates North on top of the stator, and Blue South on top of the stator. The Rotor is on top of the stator, is composed of a long magnet, with North facing the stator. Hence the rotor is attracted to the blue areas (having South on top), and repelled from the red areas (having North on top). The rotor magnet is attracted more where the stator has a larger magnet (more blue) (there are other ways of doing this—more powerful materials, etc., as explained before—Section 3). The total force is given by the signed sum of the torques due to the interactions between the rotor and stator magnets, and is related to the slope of the stator magnetic profile curve, as per Section 2. The magnetic profile of the stator has been designed to exactly cancel the torque ripple of the slider-crank, as further explained below. The residual ripple of a few percent is due to the finite number of magnets (180). It will vanish if we use a continuously variable magnetic profile.

In FIG. 9(a) till 45 degrees, the mean torque is greater than the torque delivered by the slider-crank, and requires the magnetics to add to the output torque. The amount of additional torque is large at 0 degrees, but decreases to zero at 45 degrees. In FIG. 9(b) the rotor, having NORTH at the bottom faces the south poles on the stator between 0 and 45 degrees. The size of the stator magnets increases with angle, but with a gradually decreasing slope. The exact slope and the size of the magnetized area on the stator depends on the shape and magnitude of the kernel. As per the discussion in Section 2, a forward force, decreasing with angle results, as required. The operation of this butterfly magnetic structure during the rest of the cycle can be understood on similar lines—comparing the required torque correction in FIG. 9(a), with the slope and polarity of the magnetic structure in FIG. 9(b).

The operation of this device can be understood by energy exchange between the magnetic field and the prime—mover. When the prime mover generates too much torque, the excess is stored in the magnetic field. When the prime mover torque needs augmentation, this pre-stored energy is released. This exchange repeats itself every cycle.

Stable equilibria, where the rotor comes to rest in the absence of prime mover force are marked in green, and unstable ones in red. The equilibrium at 45 degrees is stable, since just before this position, the force is counterclockwise, and clockwise just after this position.

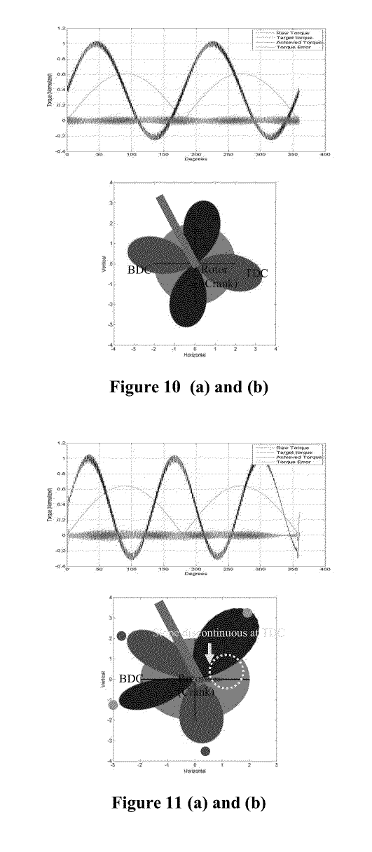

Equally interesting is the 200% ripple case, where the ripple is doubled by the magnetics (say for a rotary vibrator). The magnetic structure is shown in FIG. 10(b), and is almost 3 times as large as the zero ripple case. The magnetic profile is similar to the zero ripple case, but slightly offset in angle. This can be understood by looking at the required torque corrections in FIG. 10(a).

FIGS. 11(a) and (b) show a structure for converting the same slider crank, to a device having 200% torque ripple, and a fractional frequency of 2.7 cycles/revolution. The torque is ideally discontinuous at TDC, and this is shown by the sharp change in slope at TDC (in reality there is a non-zero transition region). Stable equilibria are marked in green, and unstable ones in red.

Dynamics of these systems is complex. In the simplest case of the system producing a constant output torque, the angular acceleration is constant, and the load moves at a linearly increasing angular velocity. In the presence of torque ripple, at each angular position, the load sees different torques, leading to nonlinear dynamics. If the torque ripple has a single frequency, the resulting dynamic equation resemble the large amplitude oscillations of a pendulum, and can be integrated using Elliptic Integrals.

Torque Smoothing of 1 KW, 2-cylinder, 2-stroke engine

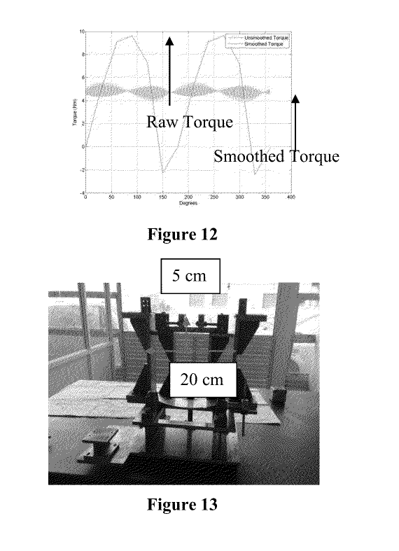

Our ideas are practical. By putting magnets in a structure similar to FIG. 9(b) on an IC engine crankshaft, we can reduce the torque ripple to zero. In FIG. 12 (photograph in FIG. 13) the raw torque of a 2-cylinder 2-stroke engine ranges from 10 Nm during peak combustion, to −2 Nm during compression. By comparison, the smoothed torque with 180 magnets on the circumference of the flywheel produced by the SVD analysis shows an almost constant mean of 5 Nm, ripple of 1.8 Nm, together with a high frequency harmonic—this is caused by the finite number of sectors used, and the resulting discrete changes in the magnetic strength.

Such structures have the following advantages over a normal flywheel
The magnetic force angular profile can be designed to exactly cancel the residual torque ripple, and make the engine look like a constant torque prime mover. In practice, due to variations in the engine torque diagram, the reduction in torque ripple across a number of engines will not be 100%, but the reduction is substantial—75% or more.
The smoothing is speed invariant, and works at low speeds too, where a flywheel is ineffective.
The magnetics is lighter and has less inertia than a flywheel.

### Specific Embodient of the Design Optimization Method

In this section, we provide more details about one embodiment of the design process. The design procedure described in this invention proceeds in two phases, for a general manipulator, once the type of mechanism is determined:
1. Determination of the magnetic forces/torques required at each joint (epair), in each configuration of the manipulator. This is achieved in general, by considering the force/torque required/specified at the end-effector (as per desired statics/dynamics), and using standard inverse kinematic equations to reflect them back to the ith joint (using transformation matrices, for example). This step can also be realized, if convenient on an energy basis, using Lagrangian methods.
2. Realization of these forces/torques (or energy profiles) using magnetics for each epair, appropriately designed, as per Equations (6) and (7). This step essentially proceeds from determining the behavior of an elementary magnet (the kernel), and then composing the kernels of multiple elementary magnets. The strengths of the elementary magnets are determined in this process. In this step we can incorporate constraints on the realizable equivalent strengths (maxima and/or minima), geometric constraints on magnetic profiles (maximum/minimum dimensions, equality of sizes of different magnets for ease of manufacturability, etc.) Different kinds of convex and non-convex constraints and objective function have been discussed in detail in the description.
3. If required, the synthesized EMEC can be analyzed/simulated to determine how accurately the input specification is met.

As an example, a slider-crank with magnetics can give a constant output torque, even with a constant input torque—the raw torque produced by a slider-crank is oscillatory. It can also give an output torque with greater variation than what is produced by the slider crank alone.

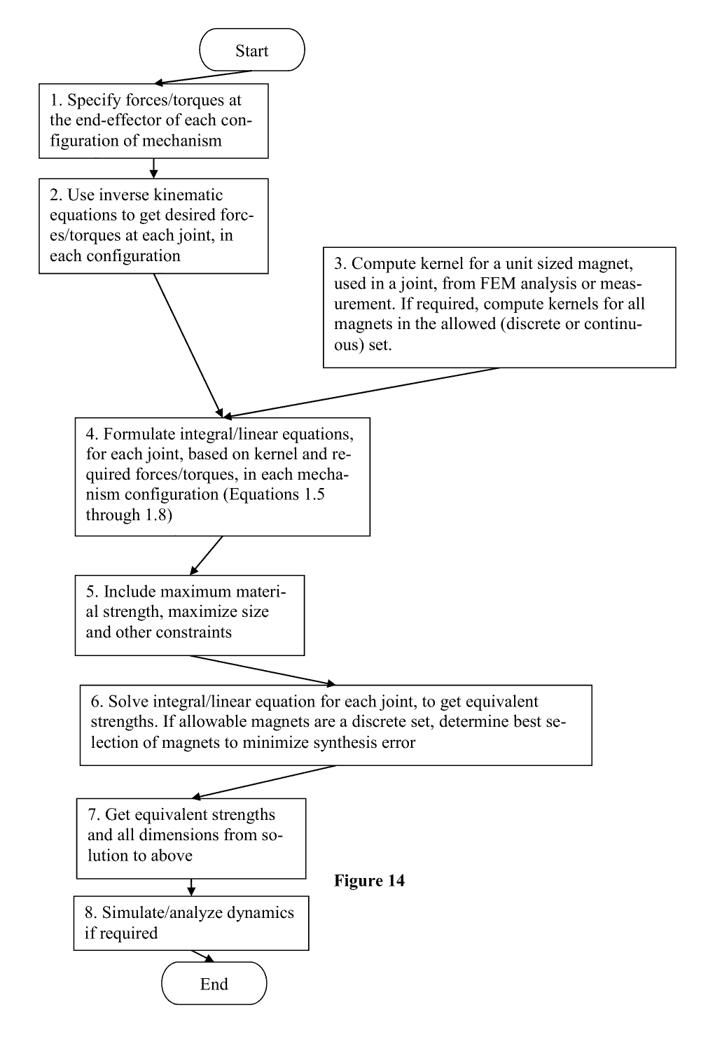

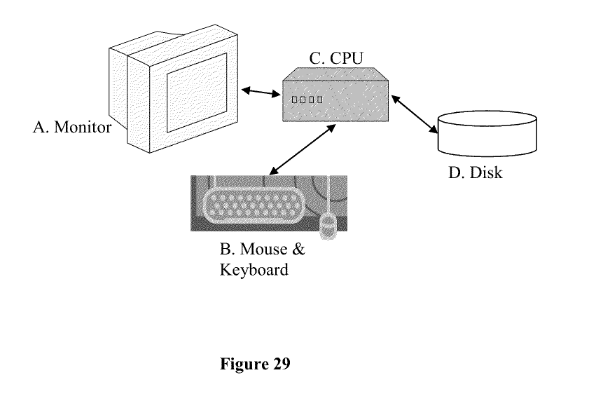

A flowchart representation of the procedure is shown in FIG. 14. All the steps of this flowchart can be incorporated in an EMEC software package, working on a state-of-art laptop or similar machine, accessing standard MCAD databases. FIG. 29 shows a general purpose computer system that may run this software. Specifically
1. In step 1, the required forces/torques at the end-effector (for desired statics/dynamics), in each configuration of the mechanism are specified. This is the input to the problem. If we need to synthesize a stepper mechanism, the input here is the stable positions and the energy wells at each position (see description). This input can be given through a GUI using the mouse/keyboard.
2. In step 2, standard inverse kinematic equations used for mechanisms (or other methods), are used to reflect the end effector forces/torque to the required forces/torques at each joint, in each configuration. This step yields the force/torque at each joint, as a function of the local joint variable (i.e., the angular position in the case of a revolute joint). These equations can be solved in the CPU of the computer for this step.
3. Step 3 computes the force/torque for a pair of elementary magnets, using FEM and/or other techniques. The complete EMEC is built using a multitude of these elementary magnets. The number of elementary magnets used in different places of the EMEC varies (and is equivalent to having a different equivalent strength in that place), and is determined using Equations 5, 6, 7, and 8, in steps 4, 5 and 6 below. If all possible equivalent strengths cannot be manufactured, this step determines the set of kernels which can be manufactured. This step can also be computed in the CPU.
4. In step 4, Equations 5 through 8 are formulated for each joint, using the kernel determined in step 3 and the required force/torques as a function of the joint variable, determined in step 2. These can be pre-computed and stored in a database on the Disk. In this step, the software can simply retrieve these equations from the data-base.
5. In step 5, additional constraints (if present) on the maximum material magnetic strength, the maximum dimensions allowed, etc., are included (please see the description on Constraints/Objective function for details). This can be done in the CPU, or retrieved from the database on the Disk.
6. Steps 6, 7 solve the resulting integral/linear equation, and determine the number of elementary magnets used in different portions of each joint in the EMEC. Determining the number of elementary magnets is equivalent to determining the equivalent strength and/or dimensions of all the magnetized areas, as described in the invention. The realization of these equivalent strengths can be by building smaller/bigger magnets, putting weaker/stronger material, changing air-gaps, etc. If all possible kernels cannot be manufactured, this optimization is equivalent to selection amongst the step which can be manufactured, and requires heuristics to solve the typically NP-hard problems. This can also be done in the CPU, or retrieved from the database on the Disk.
7. The resulting EMEC can be analyzed/simulated to see the synthesized force/torque at each configuration, and the error compared with the specification.

### A Simple Example

A simplified example will illustrate the method. Consider a 1-R mechanism, comprising a single revolute pair, enhanced with a single magnet on one member of the pair (rotor), and a multitude of magnets on the other member of the pair (stator). We use the discretized version of the formulation (Equation (7)).

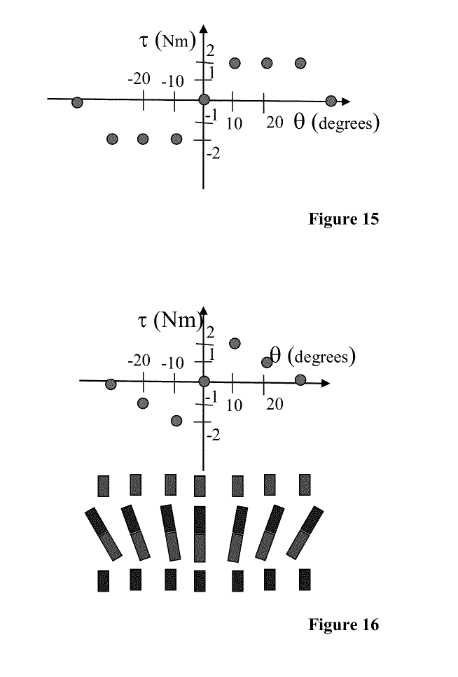

Our target torque is approximately a square wave, specified over −40 to 40 degrees (9 points), and is shown in FIG. 15. Since this is a single revolute pair, inversekinematics to determine forces/torques at each pair is not required—step 2 is skipped.

To keep the example simple, we assume that in Step 3, FEM analysis has determined a torque kernel composed of 5 points (FIG. 16), spaced apart by 10 degrees each. The torque is zero when the rotor and a single pair of stator magnets are aligned, peaks at 2 Nm at 10 degrees separation, reduces to 10 Nm at 20 degrees, and goes down to zero at 30 degrees separation between rotor and single pair of stator magnets. The rotor and a single pair of stator magnets are depicted in FIG. 16 also.

To synthesize the target, we use 5 magnets, centered at −20, −10, 0, 10, and 20 degrees respectively. These magnets are of different equivalent strengths K₋₂, K₁, K₀, K₁ and K₂ respectively, which is determined using the equations below, determined in steps 4:

$$[ \begin{matrix}- 1 & 0 & 0 & 0 & 0 \\ - 2 & - 1 & 0 & 0 & 0 \\ 0 & - 2 & - 1 & 0 & 0 \\ 2 & 0 & - 2 & - 1 & 0 \\ 1 & 2 & 0 & - 2 & - 1 \\ 0 & 1 & 2 & 0 & - 2 \\ 0 & 0 & 1 & 2 & 0 \\ 0 & 0 & 0 & 1 & 2 \\ 0 & 0 & 0 & 0 & 1\end{matrix} ] [ \begin{matrix}{K}_{- 2} \\ {K}_{- 1} \\ {K}_{0} \\ {K}_{1} \\ {K}_{2}\end{matrix} ] = [ \begin{matrix}0 \\ - 2 \\ - 2 \\ - 2 \\ 0 \\ 2 \\ 2 \\ 2 \\ 0\end{matrix} ]$$

This is an overdetermined system, and can be solved only approximately. If we want to minimize the L2 norm, SVD techniques can be used. The solution comes out to be the vector

[0.5333,0.5333,1.2000,0.5333,0.5333]

With a realized target torque of

[−0.5333,−1.6000,−2.2667,−1.8667,0.0000,1.8667,2.2667,1.6000,0.5333] Nm

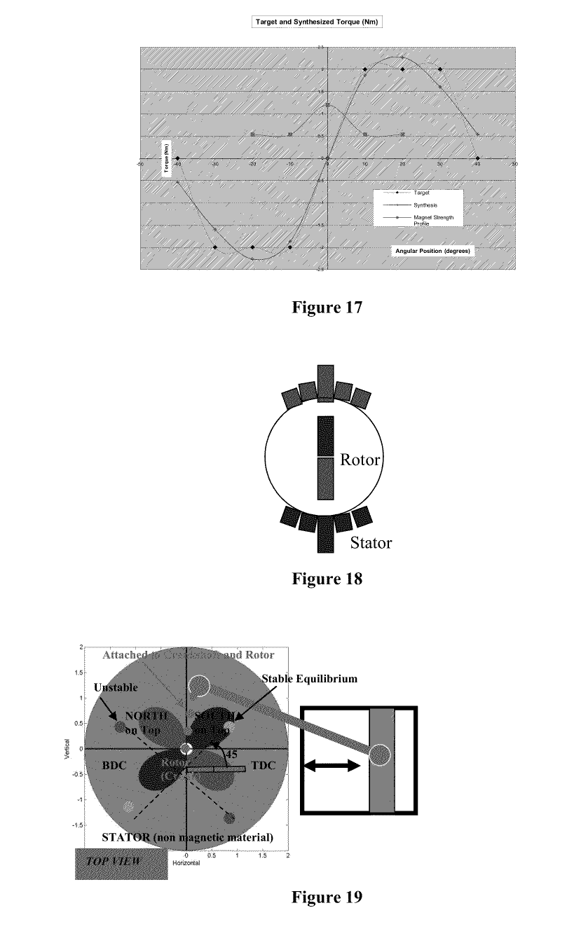

This is shown in FIG. 17, where the magnet equivalent strength profile, the targeted torque and the resultant torque are shown. The residual error (10 to 15%) can be reduced by using more and/or more closely spaced magnets. If the maximum magnet strength is limited to 1.0 (say), a convex optimizer has to be used, to do the constrained minimization.

The synthesized structure is shown in FIG. 18. The magnetics in the stator is inhomogeneous, with the lengths varying as a function of angle. Note that this structure realizes the equivalents strengths (0.53, 0.53, 1.2, 0.53, 0.53), by changing the lengths of the stator magnets, but the same can be done by changing their magnetic strengths keeping the dimensions the same, etc.

If a different target torque function is to be realized, then the stator structure will change. If we utilize the freedom to utilize multiple magnets in the rotor also, general quadratic programming techniques are required to determine all equivalent strengths and dimensions. Equations (4) through (7) can still be used with modifications. If Gaussian quadratures are used to approximate the integrals, then the angular extent of different magnets will in general be different.

Design of IC engine flywheel as per described method

FIG. 19 (redrawn from FIG. 19) shows a magnetic flywheel for an IC engine, designed using the method outlined in FIG. 14.

First, given that the structure has to oppose the excess torque of the engine during power, and aid the deficient torque of the engine during compression, the target torque produced by the magnetics is determined (step 1). Step 2 is skipped, since we have only a single revolute pair.

Then, for the materials and thickness of the rotor/stator, the kernel is determined (step 3)). This determines the elementary attraction between two unit sized stator and rotor pieces.

In step 4, the magnetic structure is designed using Equations (6) and (7). This step determines the sizes of the magnetized areas on the stator, and also the polarity, and is shown above (the butterfly structure). The magnetized area are embedded in a non-magnetic material comprising the rest of the stator.

Step 5 includes any auxiliary constraints, etc., and step 6 actually does the optimization to determine the equivalent strengths. Step 7 realizes these equivalent strengths using size modulation, material strength modulation, etc.

In this embodiment the rotor is kept at unit size, and the rotor does not have a profile. In general the rotor can also have a profile, leading to quadratic programming. The geometry of the stator/rotor can differ from that shown, we can use changes in material strength also instead of/together with change in magnetized area.

Examples of Other Devices which can be Optimized by the Method

### A Double Rocker

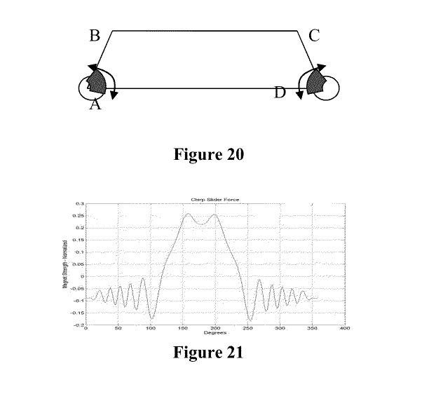

Consider the double-rocker mechanism in FIG. 20. This furnishes an example of a device composed of two “half motors”, neither of which can be eliminated without introducing singularities at either B or C. Neither motors need act on all 360 degrees of the joint's rotation. The slider crank mechanism can do with magnetic enhancement on only the crank.

A device transforming a Constant Crank Torque->Chirp Slider Force

FIG. 21, FIG. 22, and FIG. 23 show the stator enhancement of a slider-crank mechanism. The crank stator is enhanced with magnets such that a constant torque results in a “chirp—a linearly increasing frequency” in the delivered slider force. The chirp linearly increases in frequency from zero up to 10 cycles/stroke from BDC to TDC. Figure 2 shows the magnet field strength with as a function of angular position measured from TDC. The convention is repulsive and a negative field strength corresponds to a polarity reversal.

When implemented using modulation of area, the resulting magnetized area in the stator is shown laid out linearly in FIG. 22 (a) and the top view of the actual stator in FIG. 22 (b) (please use magnification). Red (Blue) implies a North Pole (South Pole) facing the North pole of the single rotor (crank) magnet (shown superposed in a unbalanced configuration in FIG. 22 (b)—balancing can be done by adding a 180 degrees rotated copy on the same shaft). Grey implies a non-magnetized area. This implies a repulsive local force—the global force has to be obtained through a global summation as per Equations (2) to (7) in the description. A 3-D FEM model has to be used to predict the force.

The green circles are stable states—the red-valleys or blue peaks, since the force around these angular positions is forward just before and backward just after these positions. Due to the chirp, these positions are not uniformly spaced in crank angle or slider position. This is a simple example of a stepper mechanism.

As discussed in the text (below Equation (6)—objective function), we can optimize the rotor and stator magnets jointly using quadratic-programming. We have used this simple lightweight structure as it results in linear optimizations, adequate performance and a very low inertia rotor, improving dynamics.

FIG. 23(a) shows the torque and FIG. 23(b) the force. We have an inhomogeneous magnetic system, yielding a chirp force increasing from zero cycles/revolution at the crank position at BDC to 10 cycles/revolution TDC (two extremes of slider motion). At BDC, the magnetized area is very slowly changing with angle, and the slider force hardly changes with slider linear position. However, the stator magnet field strength rapidly changes at TDC, resulting in a high frequency chip at the slider. While the torque is symmetric about TDC/BDC, the force reverses sign, since the motion is reversed. This enables non-zero power output to be transferred from crank to slider. The singular regions TDC/BDC+/−5 degrees are not included in the optimization—the force tends to infinity there for even an infinitesimal torque.

We stress that FIG. 22 shows one realization of modulation of magnetic strength. Other implementations, including those changing material properties to fit the field variations, while keeping area constant, are also possible.

Many other examples can be given, including more sophisticated stepper mechanisms, position sensors which display thresholds, etc.

### A General Stepper Mechanism

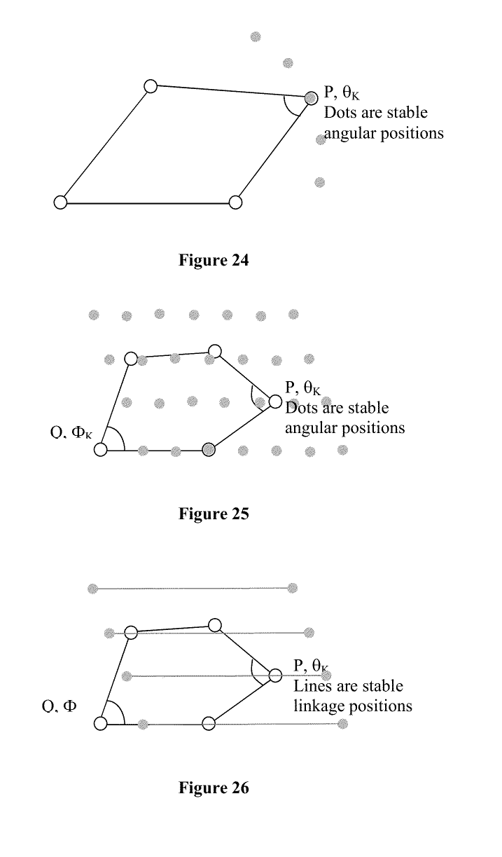

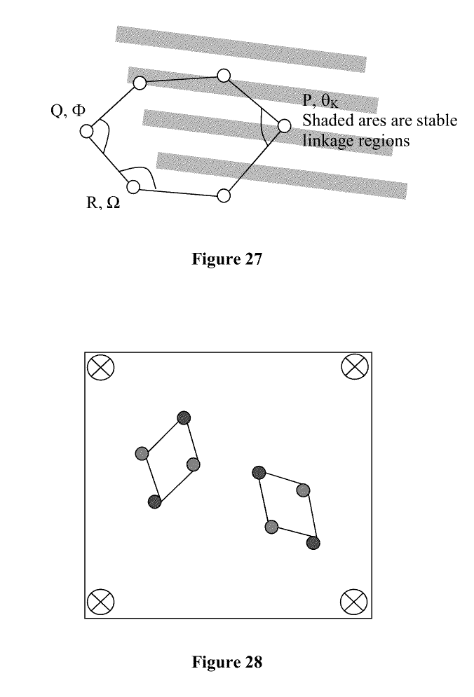

FIGS. 24, 25, 26, and 27 show examples of k-bar linkages which offer different kinds of stable states. Generically we shall refer to these as stepper mechanisms. These stepper mechanism can have stable states which are
1. Points on a discrete grid (FIG. 24): This can be synthesized (amongst other methods) using a 4-bar linkage with one epair, marked “P”, with stable angular positions (stable states) θ_{K}. As the mechanism configuration is changed by moving any one free pair, P moves from one stable position to another, generating a sequence of discrete stable positions shown as dots in FIG. 24. In FIG. 25, a 5-bar linkage, with two epairs P and Q with stable angular positions θ_{K} and θ_{K} respectively is shown. The stable positions of the linkage are in a 2-D grid.
2. Curves separated from each other (FIG. 26): In FIG. 26, the same 5-bar linkage is shown as in FIG. 25, except that Q can be moved continuously (within limits). Now the discrete points are linked, and a set of curves separated from each other results. The mechanism exhibits a set of stable curves. Adding magnetic barriers to Q (i.e. Q allows free motions, within limits which can be exemplarily realized by repulsive magnets coming close to each other at the limits), is one way of limiting the extent of these curves.
3. Areas separated from each other (FIG. 27): The same ideas are generalized in FIG. 27. A 6-bar linkage, P having discrete stable angular positions θ_{K}, and the others (Q and R) free is one way of synthesizing this. The area is generated by continuously moving the two free epairs, keeping P at a stable angular position. Area limits can be generated as in case (2).
4. Robots flying on a carrom board (FIG. 28): An extension of these ideas is the robots flying on a carom board in FIG. 28. The robots are exemplarily 4-bar (or K-bar) linkages with epairs, designed with specified stable states. Magnets attached beneath the board introduce more stable states by interacting with the magnets on the linkages. The interaction of all these stable states introduces challenging dynamics for playing this game, to move the linkages to specified pockets, in a specified configuration.

### REFERENCES

[1]. Ghoshal, A, Robotics: Fundamental Concepts and Analysis, Oxford Univ Press, 2006.
[2]. Uiker, Pennock, Shigley, Theory of Machines and Mechanisms, Oxford, III Edition.
[3]. Ghosh, A. and Mallik, A. K, Mechanisms and Machines, III Edition.
[4]. Myszka, Machines and Mechanisms: Applied Kinematic Analysis, Prentice Hall, 2004.
[5]. Nakamura, Y. Advanced Robotics, Redundancy and Optimization, Addison Wesley, 1991.
[6]. Kim, S, “Optimal Redundant Actuation of Close-Chain Mechanisms for High Operational Stiffness”, IEEE/RSJ Proc 2000 IEEE/RSJ Internl. Conf. on Intelligent Robots and Systems.
[7]. Hirose, S and Arikawa, H, “Coupled and Decoupled Actuation of Robotic Mechanisms”, Proc. of 2000 IEEE Intl. Conf. on Robotics and Automation, San Francisco, Calif., 2000.
[8]. Press et al, Numerical Recipes, the art of Scientific Computation, Cambridge Univ Press
[9]. Liang Yan; I-Ming Chen; Ghee Kian Lim; Guilin Yang; Wei Lin; Kok-Meng Lee, “Design and Analysis of a Permanent Magnet Spherical Actuator”, IEEE/ASME Trans on Mechatronics, April 2008, pp 239-248.
[10]. H. J. Van de Straete; J. De Schutter, “Hybrid cam mechanisms”, IEEE/ASME trans. Mechatronics. December 1996, pp 284-289.
[11]. Ohnishi; K. Shibata; M, Murakami, T “Motion control for advanced mechatronics”, IEEE Trans Mech, March 1996, pp 56-67;
[12]. Arimoto, S, and Nakayama, T, “Another language for describing motions of mechatronics systems: a nonlinear position-dependent circuit theory”, IEEE Trans Mech, June '96, pp 168-180.
[13]. Yamaguchi, T.; Numasato, H.; Hirai, H, “A mode-switching control for motion control and its application to disk drives: design of optimal mode-switching conditions”, IEEE Trans Mech, September 1998, pp 202-209.
[14]. Dixon, W. E., “Adaptive Regulation of Amplitude Limited Robot Manipulators With Uncertain Kinematics and Dynamics”, IEEE Trans. On Automatic Control, March 2007.
[15]. Boldea, I. Nasar, S. A, “Linear electric actuators and generators”, IEEE Trans Energy Conversion, September '99, Vol 14, Issue 3, pp 712-717.
[16]. Guiying Song, Hexu Sun, Yi Zheng, “Study of the control strategy for mechatronics system of electric actuator”, Intl. Conf on Electrical Machines and Systems, October 07, pp 1584-1587.
[17]. Economou, J. T. Tsourdos, A, Luk, P. C. K., White, B. A. “Intelligent control of a multi-actuator mobile robot with competing factors”, IEEE Conf. on Fuzzy Systems 2003, May 2003, pp 302-306.
[18]. Hungsun Son; Kok-Meng Lee, “Distributed Multipole Models for Design and Control of PM Actuators and Sensors”, IEEE Transactions on Mechatronics, Vol 13 No 2, April 2008, pp 228-238.
[19]. Aghili, F. Hollerbach, J.M. Buehler, M, “A Modular and High-Precision Motion Control System With an Integrated Motor”, IEEE Trans. on Mechatronics, June 2007, pp 317-329.
[20]. Finite Element Method Magnetics: Home Page: Available at http://femm.foster-miller.net
[21]. Eric Denisson: Available at http://www.netdenizen.com/emagnet/offaxis/iloopoffaxis.html [22]. G. N. S. Prasanna, Gowthaman, and Manjunath Prasad, Electrical Mechanisms: A merger of mechanisms and Electrical Machines, in Proceedings of National Conference on Mechanisms and Machines, Bangalore, 2007.
[23]. Haus, H and Melcher, Electromagnetic Fields, Forces and Motion, Prentice-Hall, Englewood Cliffs, N.J.: Prentice-Hall, 1989. ISBN: 9780132490207.
[24]. Jordan and Balmain, Electromagnetic Waves and Radiating Systems, Prentice-Hall, Englewood Cliffs, N.J.,
[25]. Boyd, Convex Optimization, Cambridge Univ Press, 2007.
[26]. Press, et al: Numerical Recipes: The Art of Scientific Computing III Edition, Cambridge Univ Press, 20007.

1. A method, including constraints, and databases, for designing components of electrical mechanisms, comprising the steps of:
(a) comparing different specifications based on polyhedral geometry;
(b) designing serial electrical mechanisms;
(c) designing parallel electrical mechanisms;
(d) designing a 4-bar linkage with rest states;
(i) defining energy in each global configuration (1 dimensional);
(ii) assigning a portion of energy to each epair in its local configuration;
(iii) designing epairs;
(e) designing stepper mechanism with rest states; and
(f) As above, wherein the configuration is N-dimensional to specify energy.

2. The method according to claim 1, wherein optimization is performed using standard sized magnets such that a wide variety of constraints can be incorporated in the formulations of ELECTRICAL MECHANISMS wherein, maximum and minimum limits on equivalent strengths or the kernel itself.

3. The method according to claim 1, wherein at least one constraint is applied such that total magnetic material used in the mechanism may be limited due to exemplarily space constraints.

4. The method according to claim 1, wherein at least one constraint is applied such that the rate of change of equivalent strengths and/or the kernel, due to manufacturing limitations.

5. The method according to claim 1, wherein at least one constraint is applied such that several equivalent strengths can be set equal to each other to simplify manufacturing, since fewer sizes of magnets have to be fabricated.

6. The method according to claim 1, wherein at least one constraint is applied such that maximum change in the field as the mechanism moves may be limited to enhance material stability by limiting demagnetizing fields.

7. The method according to claim 1, wherein at least one constraint is applied such that there are limits to the internal magnetic forces at different configurations in the mechanism, as it moves.

8. The method according to claim 1, wherein, the stable/unstable states are specified at various positions, along with the maximum holding force, and the magnetics are designed to yield these states.

9. An apparatus for designing components of electrical mechanisms, comprising:
(a) a first component having at least one electromagnetic elements; and
(b) a second component having at least one electromagnetic elements and movably coupled to the first component,
wherein the second component is adapted to move with respect to the first component in a cyclical manner; and the at least one electromagnetic elements of the first component are adapted to interact with the at least one electromagnetic elements of the second component during each of one or more cycles of motion of the second component with respect to the first component such that, when a constant force profile applied to move the second component with respect to the first component, the speed of motion increases and decreases at least one time during each cycle of motion due to different levels of electromagnetic interaction between the electromagnetic elements within each cycle of motion.

10. The apparatus according to claim 9, further comprising a 4-bar linkage that is a double rocker device, with a revolute joint enhanced with magnets such that the magnetic force or torque exerted by said magnets at said joint is not uniform over the cycle of motion of the device.

11. The apparatus according to claim 9, which is a chirp generator device, with a revolute joint enhanced with magnets such that the magnetic force or torque exerted by said magnets at said joint varies in a sinusoidal fashion, with increasing frequency over a cycle of motion of the device.

12. The apparatus according to claim 9, which is a vibration enhancer, with a revolute joint enhanced with magnets such that the magnetic force or torque exerted by said magnets at said joint varies in a sinusoidal fashion, with increasing frequency over a cycle of motion of the device.

13. The apparatus according to claim 9, which is a sinusoidal output converter, with a revolute joint enhanced with magnets such that the magnetic force or torque exerted by said magnets at said joint varies in a sinusoidal fashion, with increasing frequency over a cycle of motion of the device.

14. The apparatus according to claim 9, which is an IC engine flywheel, with a revolute joint enhanced with magnets such that the magnetic force or torque exerted by said magnets at said joint varies in a sinusoidal fashion, with increasing frequency over a cycle of motion of the device.

15. The apparatus according to claim 9, which is a 4 bar linkage, with a revolute joint enhanced with magnets such that the magnetic force or torque exerted by said magnets at said joint varies in a sinusoidal fashion, with increasing frequency over a cycle of motion of the device.

16. The apparatus according to claim 9, which is a magnetic carom, with a revolute joint enhanced with magnets such that the magnetic force or torque exerted by said magnets at said joint varies in a sinusoidal fashion, with increasing frequency over a cycle of motion of the device.

17. The apparatus according to claim 9, comprising irregularly shaped magnets that are attached to different parts of the mechanism to provide customizable tangential forces in different configurations.

18. The apparatus according to claim 9, wherein the magnets are designed based on integral equations involving continuous and/or discrete variables, under a variety of constraints.

19. The apparatus according to claim 9, wherein the total force applied is non-constant so as to result in non-constant acceleration that is achieved by using internal electromagnetic forces.

20. The apparatus according to claim 9, wherein a portion of the applied force is provided by the internal structure of the mechanism to provide a non-constant acceleration even if the applied external force is constant.

21. The apparatus according to claim 9, wherein a Prismatic active EMEC has the strength of the pole pieces increases and decreases in a sinusoidal fashion with position with irregular spacing.

22. The apparatus according to claim 21 wherein the total force F12 changes as the links where the two magnets are attached slide relative to each other, due to change in elemental force which in turn is due to the change in the distance between two elemental current densities.

23. The apparatus according to claim 21 wherein the kernel is computed by finite-element methods, given the shape and properties of M1.

24. The apparatus according to claim 9, wherein the apparatus can design slider-crack mechanisms that can present oscillatory forces to the load, even when driven by a constant force.

25. The apparatus according to claim 9, wherein, when attached to an IC engine, results in the engine producing a position and speed independent smooth torque with zero ripples.
